(19) United States
(12) Patent Application Publication
(10) Pub. No.: US 2006/0136200 A1
(43) Pub. Date: Jun. 22, 2006

(54) Intelligent active talker level control

(76) Inventors: Amin F. Rhemtulla, Rockaway, NJ (US); Siu H. Lam, Woodeliff Lake, NJ (US); Kai X. Miao, Boonton Township, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/020,690

(22) Filed: Dec. 22, 2004

(51) Int. Cl. G10L 11/06

(52) U.S. Cl. 704/214

(57) ABSTRACT

Embodiments of the invention provide a method and apparatus for adjusting the gain of conference users including a separate input gain for each user and an output gain for each user. The input gain may be determined in response to whether active audio is detected. Users may be classified as dominant speakers or passive participants. A separate class of input gain levels may be provided for dominant speakers (higher) and passive participants (lower). The input gain may be inversely proportional to user input energy level for dominant speakers. The output gain may be inversely proportional to user input energy level.

### BACKGROUND

Implementations of the claimed invention generally may relate to the field of telecommunications and, more particularly, to conferencing systems.

Conferencing technology enables the users of two or more people at geographically remote locations to have audio communication with each other. With the growth of multimedia and Internet applications, the use of conferencing may become even more popular in the future, not only in business but also in our everyday lives. However, as conferencing finds more usage, the conference size requirement may also likely increase. Today it is not uncommon to have a conference call that has ten or more users.

One conventional method to implement a conferencing system is to sum the audio streams of every user together and the result is then sent to all users. However, as the number of users of a conference call increases, it may become unpractical to sum all the users since the result will typically overflow and the accumulation of noise in the sum may also cause quality problems.

In another method, a conferencing system automatically detects a few of the loudest audio streams in a conference, identified as the active talkers, and then arithmetically adds these streams to create a sum. This method may have limitations, including but not limited to degrading conferencing quality under certain situations. In particular, because only a small subset of conferees may be allowed to talk, this method may not be capable of capturing all the audio information and accurately reflect the actual dynamics of a real life conference. Some users may be cut off inappropriately since not everyone's voice can be captured when this method is used or each user will try to speak ever louder to get to be the active talker.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system of a two-stage level control for conference users;

FIG. 2 illustrates the intelligent gain control in the example system of FIG. 1; and

FIG. 3 is a flow chart illustrating a process of providing intelligent gain control for conference users.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

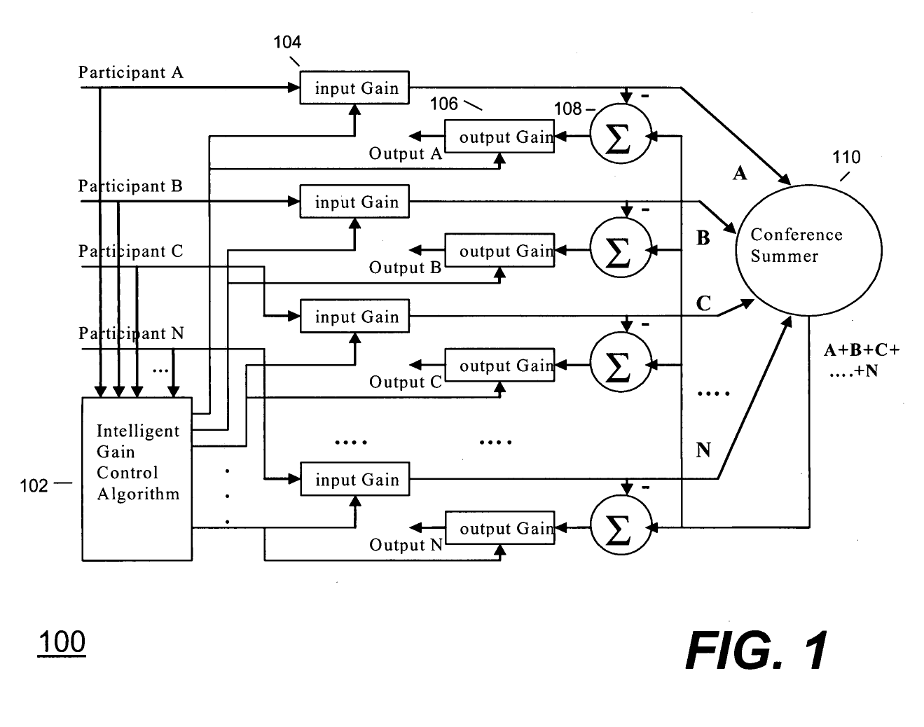

FIG. 1 illustrates an example system 100 of a dual stage gain control for conference users A-N. System 100 includes gain control algorithm 102, conference summer 110 and for each user input gain element 104, output gain element 106 and user summer 108. Input gain element 104 is provided before each user's audio is summed by conference summer 110, and output gain element 106 is provided before each individual summed conference output to each user. As shown in FIG. 1, these individual gain settings 104 and 106 may be controlled by intelligent gain control element 102.

Output gain element 106 controls the level of the conference audio to each user. This gain may be set to be inversely proportional to the energy of the input audio of the user. In other words, the louder a user talks, the lower the volume of the conference audio back to that user. This helps to limit the tendency to talk louder when the environment is noisier. When the user is not talking, the output gain may be set to unity. There is a selectable lower threshold to the output gain. The output gain setting may be implemented by a simple table lookup.

Intelligent gain control may be used to lower all of the user's input via the input gain element by a proportional amount so when you add them up there is no overflow. For example, if users A and B are speaking, A and B would be added. Other users are added too in case they interject something. These other users are captured too but their gain is lowered. Two classes of users may be established: active talkers (A and B) and less active users. Active users get most of the share and their gain level is set accordingly to the input level of each of the users. In particular, the output gain level is inversely proportional to the level of their voice. If you the user talks loudly, the user's level is adjusted down more.

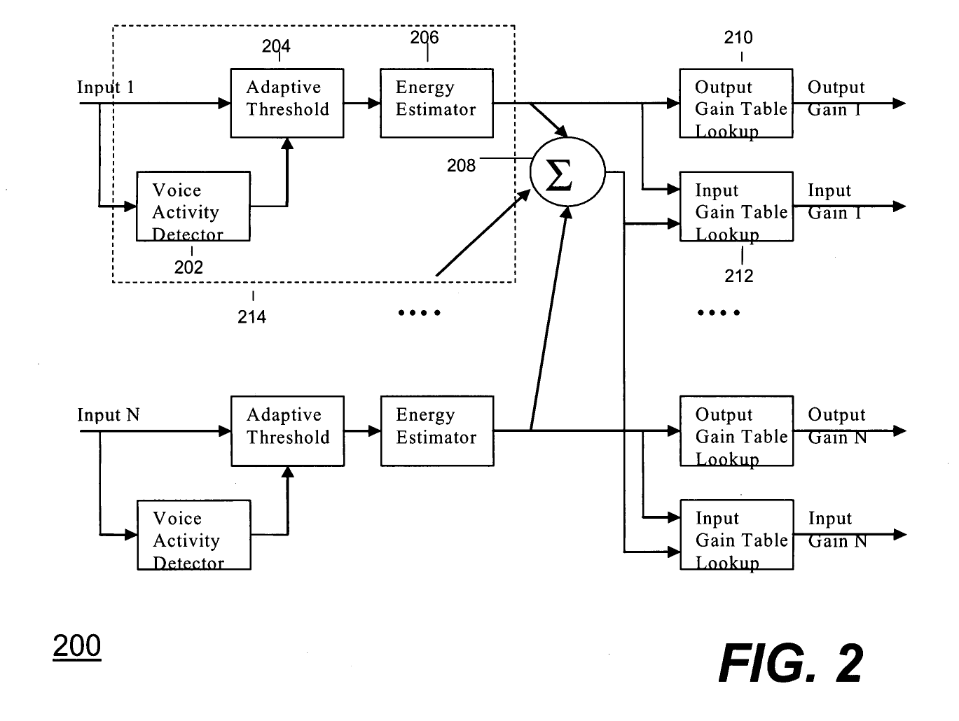

FIG. 2 illustrates the intelligent gain control 200 in the example system of FIG. 1. Intelligent gain control algorithm 214 includes voice activity detector 202, adaptive threshold 204 and energy estimator 206. Output of gain control algorithm 214 is applied to both input and output gain control blocks 210 and 212. Gain may be determined by voice activity detector 202 and adaptive threshold 204. Adaptive threshold 204 along with voice activity detector 202 determines what the background noise is.

Voice activity detector 202 tracks the input audio and updates the adaptive threshold based on the average background noise level. Adaptive threshold 204 gates off unwanted background noise. This helps to eliminate noise input from users from noisy background (for example, users using a cell phone connection). The initial consideration for determining the level of gain applied to each user is the signal level of the user audio. If the level is very high, gain is lower and vice versa. The overall energy levels of the active users which passed their individual thresholds are used to determine the input gain levels in an inversely proportional manner. In other words, the higher the overall energy, the lower the input gains.

In particular, voice activity detector 202 detects voice and minimizes the amount of noise added into the conference. In a typical implementation, voice activity detector 202 cuts off if there is no voice activity. Audio data is received by voice activity detector 202 from an audio channel. Signal, which contains audio data, is then output by voice activity detector 202. The energy of the audio signal has a waveform. The portion of the waveform which exceeds a noise floor is considered to be speech energy, whereas the portions of the waveform not exceeding the noise floor are considered to be only noise energy. But if there is some voice activity and the user does not have a history as an active talker, the user is still allowed in although at a lower gain. For example, if there is no audio but just background noise such as from a cell phone caller, voice activity detector 202 minimizes the likelihood of static background noise ruining the conference. The history of the conference user is also taken into consideration. In particular, which user has been more actively talking. That may also be used to determine the level of gain is applied.

Voice activity detector 202 initially determines whether there is any active audio.

If voice activity detector 202 detects no active audio, then output of energy estimator 206 is zero.

If voice activity detector 202 detects active audio, energy estimator 206 determines how much energy is in the signal. Energy estimator 206 determines the length of time a user talks. That information is also used to determine what the gain is. Output from energy estimator 206 is applied to both input and output gain determination for that particular channel.

The output of energy estimator 206 is applied to output and input gain table lookups 210 and 212, which determine the output and input gain levels. The table lookups provide levels which are generally inversely proportional to the energy level input provided by energy estimator 206. For example, if the energy detected by energy estimator 206 is high, both the input and output gain is adjusted down. If the energy detected by energy estimator 206 is low, both the input and output gain is adjusted up.

In particular, output of energy estimator 206 is applied to output gain table lookup 210 that provides an output gain signal to the user. A problem with conference calls arises when users converse at higher volume because they believe others cannot hear. For example, if the audio feedback to the user is high, the user may speak even louder to be heard. The feedback in such a situation may be lowered so that it is not as noisy. This will increase the likelihood that the high volume user returns to conversing at normal volume. The output gain signal is related to how loud the user talks. If a user talks really loud, feedback is lowered.

Output of energy estimator is applied to input gain table lookup 212. The input gains are also set individually for each user according to a hierarchy. The main active talkers, determined by the 2-4 inputs with historical most active audios as tracked by the voice activity detectors and energy estimators, are accorded proportionally higher gains. The remaining users are accorded lower gains, but nonetheless provide input to the conference. The input gain setting can also be implemented by a table lookup 212.

Output of energy estimator 206 is also applied to summer 208, which generates a second signal to input gain table lookup 212. Both inputs from energy estimator 206 and summer 208 are applied to input gain table lookup 212 and used to determine the level of input gain. For example, if the input gain is too high, all the signals may be clipped. Accordingly, if the sum of all the inputs is high, the gain may be lowered.

This allows all relevant users to be heard in a more complex conferencing environment and, at the same time, removes low background noise with much greater accuracy. It allows a conferencing system to more truly capture the meeting dynamic but simultaneously maintain the best possible overall audio volume for the total conference. All parties in a small, medium or large conference call may be heard, while maintaining a proper overall signal level.

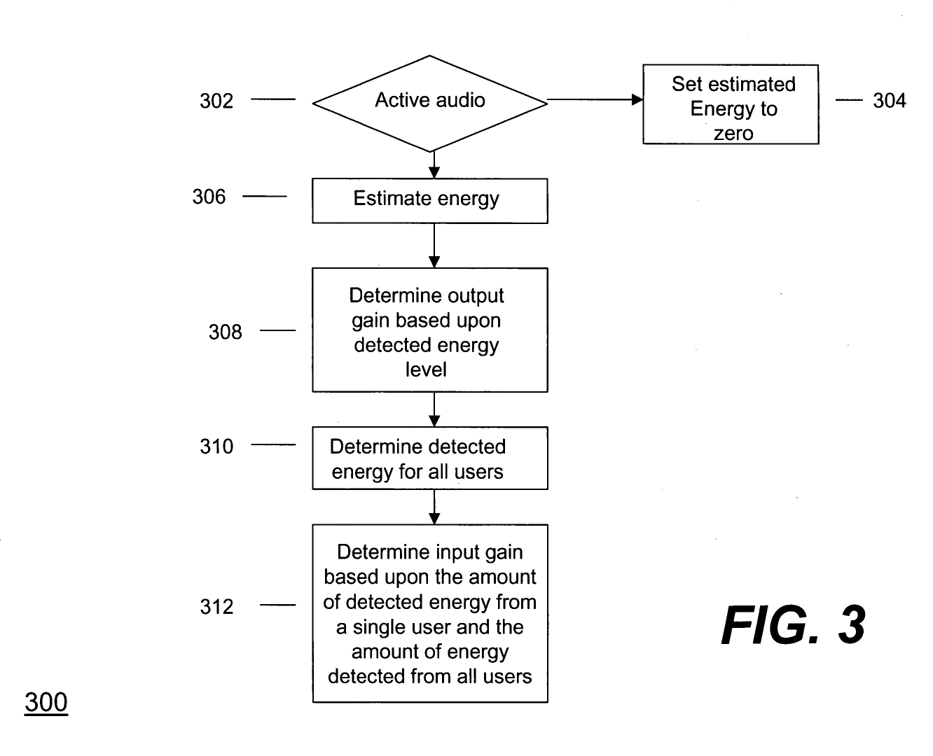

FIG. 3 is a flow chart illustrating a process of providing intelligent gain control for conference users. Although process 300 may be described with regard to system 100 for ease of explanation, the claimed invention is not limited in this regard.

It is initially determined whether there is any active audio (act 302).

If there is no active audio, then the estimated energy is set to zero (act 304).

If active audio is detected, the amount of energy is estimated (act 306). The information is also used to determine what the gain is.

Output gain is determined based upon the amount of detected energy (act 308). In one implementation, the table lookups provide levels which are generally inversely proportional to the energy level input. For example, if the energy detected is high, both the input and output gain is adjusted down. If the energy detected is low, both the input and output gain is adjusted up.

The detected energy for all the users is then determined (act 310).

Input gain is determined based upon the amount of detected energy from a single user and the amount of energy detected from all of the users (act 312). The input gains are also set individually for each user according to a hierarchy. The main active talkers, determined by the 2-4 inputs with historical most active audios as tracked by the voice activity detectors and energy estimators, are accorded proportionally higher gains. The remaining users are accorded lower gains, but nonetheless provide input to the conference. The input gain setting can also be implemented by a table lookup.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

Moreover, the acts in FIG. 3 need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium.

No element, act, or instruction used in the description of the present application should be construed as critical or essential to the invention unless explicitly described as such. For example, the form of audio communication is not critical. In one embodiment, the audio channel may be an Integrated Services Digital Network (ISDN) link. In other embodiments, the audio channel may be a standard computer local area network (LAN), or a telephone connection. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method for adjusting the gain of conference users comprising:
for each user:
determining whether there is active audio;
in response to active audio, determining the amount of energy expended; and
determining output gain based upon the amount of detected energy;
determining the total amount of detected energy for all users; and
determining input gain based upon the amount of detected energy for a user and the total amount of energy detected for all users.

2. The method claimed in claim 1, wherein in response to active audio, determining the amount of energy expended further comprises:
determining a length of time a user talks.

3. The method claimed in claim 1, wherein determining output gain based upon the amount of detected energy further comprises:
determining an output gain level that is inversely proportional to the amount of energy detected.

4. The method claimed in claim 3, wherein determining an output gain level that is inversely proportional to the amount of energy detected comprises:
if the energy detected is high, adjusting the output gain level down and if the energy detected is low, adjusting the output gain level up.

5. The method claimed in claim 1, wherein determining output gain based upon the amount of detected energy further comprises:
in response to no detected energy, setting the input gain to zero.

6. The method claimed in claim 1, wherein determining input gain based upon the amount of detected energy for a user and the total amount of energy detected for all users further comprises:
determining an input gain level that is inversely proportional to the amount of energy detected for a user and all the users.

7. An apparatus comprising:
a voice activity detector to determine whether there is any active audio for each user;
an energy threshold to determine, in response to active audio, the amount of energy expended by each user; and
an output gain device to determine an output gain based upon the amount of detected energy for each user;
a summer to determine the total amount of detected energy for all users; and
an input gain device to determine an input gain based upon the amount of detected energy for a user and the total amount of energy detected for all users.

8. A method for adjusting the gain of conference users comprising:
providing a separate input gain for each user and an output gain for each user.

9. The method claimed in claim 8, comprising:
determining input gain in response to whether active audio is present.

10. The method claimed in claim 9, further comprising:
setting input gain to zero in response to no active audio.

11. The method claimed in claim 8, further comprising:
classifying users as dominant speakers or passive participants, wherein dominant speakers are determined in response to length of time of active audio.

12. The method claimed in claim 11, wherein the input gain is inversely proportional to user input energy level for dominant speakers.

13. The method claimed in claim 12, further comprising:
referencing a user table lookup for gain setup.

14. The method claimed in claim 8, where the output gain is inversely proportional to user input energy level.

15. The method claimed in claim 14, wherein the output gain is unity if there is no user input.

16. A system, comprising:
a memory; and
a controller to determine whether there is active audio, in response to active audio determining the amount of energy expended, determine output gain based upon the amount of detected energy, determine the total amount of detected energy for all users, and determine input gain based upon the amount of detected energy for a user and the total amount of energy detected for all users, wherein energy levels expended are saved in the memory.
